(19) United States
(12) Patent Application Publication
(10) Pub. No.: US 2010/0196560 A1
(43) Pub. Date: Aug. 5, 2010

(54) Method for Shaping Food Products by Cryo-Extrusion

(75) Inventors: Franck Cousin, Saint Brevin Les Pins (FR); Willy Frederick, Clerac (FR); Pierre Kowalewski, Paris (FR); Didier Alo, Criquetot L'Esneval (FR)

Correspondence Address: AIR LIQUIDE USA LLC;Intellectual Property, 2700 POST OAK BOULEVARD, SUITE 1800, HOUSTON, TX, 77056, US

(73) Assignee: L'Air Liquide Societe Anonyme Pour L'Etude Et L Explotation Des Procedes Georges Claude, Paris (FR)

(21) Appl. No.: 12/595,420

(22) PCT Filed: Mar. 28, 2008
(86) PCT No.: PCT/FR08/50545

§ 371 Date: Apr. 12, 2010

(30) Foreign Application Priority Data
Apr. 25, 2007 (FR) 0754682

(51) Int. Cl. A23P 1/12; B29C 47/92; B29C 47/08; A23L 3/36; A23L 1/31; A23L 1/325; A23L 1/39; A23L 1/212; A23L 1/48

(52) U.S. Cl. 426/231; 425/145; 426/589; 426/565; 426/615; 426/618; 426/549; 426/646; 426/643

(57) ABSTRACT

The invention relates to a method for shaping at least one food product by cryo-extrusion using an extruder that comprises at least one extrusion screw driven by a motor and a die at the outlet of said at least one extrusion screw, characterised in that it comprises measuring at different times tᵢ and tᵢ₊₁ the intensity I consumed by the motor, the rotation speed of said at least one extrusion screw being increased if the intensity difference ΔI between tᵢ and tᵢ₊₁ is positive and higher than a predetermined value.

The present invention relates to the field of the agri-food industry and more particularly to a process for the cold extrusion of food products in order to shape them.

The shaping of food products has become a major challenge for manufacturers in recent years. This is because consumers are demanding more and more food products in portions, with novel and varied shapes, making it possible for the amounts necessary for their meals to be easily metered and also exciting gustatory desire. Another challenge is to provide food professionals with metered products that can be easily used.

To meet this requirement, manufacturers have at their disposal various techniques, which however are not fully satisfactory.

The simplest technique is the technique using a blanking die or mold. The major drawback of this technique is that it does not allow complex shapes to be obtained nor the use of a liquid raw material; moreover, it is a major source of waste that it is difficult to reutilize on account of the ever more stringent food standards.

One technique widely used involves a “balling machine”, consisting of two counter-rotating hollow cylinders between which a food paste, whether prefrozen or not, is poured, said paste then emerging in the form of “balls”, i.e. pellets which can then undergo a freezing step. Such a process is used for the manufacture of deep-frozen products of the following types: soup in “block” form, spinach in the form of portions, etc. The products thus obtained are not satisfactory as not only do they have an unattractive external appearance, requiring the use of opaque packaging, but they also have a shape limited by the geometry of the machine, which enables only balls to be produced, and in no case playful shapes, for example for infants. Finally, it is impossible for the amount of food product of the “balls” to be precisely metered. Product losses are also substantial.

Another technique that can be used is the extrusion of food products, in particular cold extrusion. Many food products may be extruded, whether they be solids or semi-solids, such as for example bread dough, biscuits or appetizers, starches, vegetables, meat, ice creams, chocolate, soft sweets, chewing gum, fruit jellies, caramel, cereals, vegetable proteins, casein, processed cheese, animal feeds, etc., this list of course being in no way exhaustive.

Conventionally, an industrial extruder consists of a long barrel comprising at least one extruder screw inside it, a feed hopper at one of its ends and an exit nozzle at the other end. In general, the extruder screw is driven by a rotary motor, the rotation speed of which is controlled by a variable frequency supply.

During low-temperature extrusion, either the products are cooled or even frozen upstream of the extrusion step, as described for example in the document U.S. Pat. No. 4,795,650, or the products are cooled or even frozen directly in the extruder itself. In the latter case, either the cooling is carried out via the outside of the extruder, i.e. a coolant circulates around the body of the extruder, for example brine, ammonia, glycol water, liquid nitrogen or carbon dioxide, as described for example in US 2003/0211192 or US 2005/0132902, or the cooling is carried out by direct contact, by injecting a coolant into the extruded product, as described for example in the documents EP-0 250 381 and US-2006/0283196.

These processes, which in theory are attractive, cannot be easily exploited on an industrial scale since they have the major drawback of stopping the screw or screws of the extruder by too rapid a drop in the temperature of the product. This is because when the temperature of the extruded food product drops too rapidly, the viscosity of the product increases very rapidly and results in an increase in the torque on the screw or screws and therefore an increase in the motor current, thus tripping the thermal safety cut-out of the motor and therefore stopping the latter. For this reason, said cold extrusion process cannot be easily used as such in industry for the shaping of food products having a high viscosity.

Thus, the technical problem addressed by the present invention is to provide an industrial process for giving food products that are initially liquids, semi-solids and/or solids a texture solid enough to allow them to be formed into sized portions having a satisfying attractive appearance.

This problem has been solved by the present invention, which proposes an improvement to the cold extrusion process, also called cryo-extrusion. Specifically, the Applicant has, surprisingly and unexpectedly, shown during its research that at the moment when an increase in the electrical current drawn by the extruder motor is measured, due to the uncontrolled increase in the viscosity of the extruded food product, instead of stopping the motor or reducing the rotation speed of the extruder screw, astonishingly, it is advantageous to increase the rotation speed of the extruder screw, i.e. to increase the current drawn by the motor.

One subject of the present invention is therefore a process for shaping at least one food product by cryo-extrusion using an extruder comprising at least one extruder screw, driven by a motor, and a nozzle at the exit of said at least one extruder screw, characterized in that it comprises the measurement, at different times tᵢ and tᵢ₊₁, of the current I drawn by the motor, and the increase in the rotation speed of said at least one extruder screw if the difference in current ΔI between tᵢ and tᵢ₊₁ is positive.

Thus, unlike the prior art, the process is not controlled only by measuring the temperature, but also by monitoring the current drawn by the motor over the course of time or by measuring the mechanical force exerted on the screw or screws. This mechanical force expressed as torque, added to the information about the rotation speed of the screw or screws, is proportional to the current absorbed by the electric motor. It is therefore possible to implement said regulation by measuring the mechanical force and the rotation speed instead of measuring the current.

Throughout what follows, the wording “current drawn by the motor” will therefore be used, but it will be understood upon reading the foregoing that the present invention can also be implemented based on information about the mechanical force exerted on the screw or screws in combination with information about the rotation speed of the screw or screws.

The current I drawn by the motor is measured regularly, with a time interval tᵢ₊₁-tᵢ ranging from 10⁻⁴ seconds to a few seconds, preferably from 5×10⁻⁴ to 1 second and even more preferably a few milliseconds, using an ammeter connected to the motor, throughout the duration of the cryo-extrusion process. The term “difference in current ΔI between tᵢ and tᵢ₊₁” is understood to mean the difference in current Itᵢ₊₁−Itᵢ, where Itᵢ is understood to mean the current drawn by the motor at a time tᵢ and where is understood to mean the current drawn by the motor at a time tᵢ₊₁, tᵢ₊₁ corresponding to a time later than tᵢ. In general, ΔI is measured in real time, and the slight increases/decreases in current corresponding to normal operation of the extruder are compensated for so as to give an overall zero ΔI over the course of time. If the increase is sudden and continuous over two or three consecutive measurements, or if ΔI is positive over one measurement during measurements spaced apart in time, then the speed of the screw is increased. The current drawn is specific to each motor and the operator will be capable of determining the time interval with which he wishes to carry out the current measurements and the change in current to be considered as a sign of a malfunction.

The change in current is advantageously signaled by any warning system, and preferably controls the increase in rotation speed of the extruder screw or screws.

To increase the rotation speed of the extruder screw, it is conventionally sufficient to increase the frequency of the frequency generator (variable frequency supply) associated with the motor for a given time, preferably for 5 to 10 seconds. From the industrial standpoint, the increase in frequency is carried out automatically as soon as the difference in current ΔI is positive and above a predetermined setpoint.

In the context of the present invention, the term “cryo-extrusion” is understood to mean an extrusion process carried out at low temperature, preferably around the freezing point of the food product, more preferably just below the initial freezing point of the food product and even more preferably ranging from between 0.1° C. and 1° C. or even 2° C. below the freezing point of the food product. It is quite obvious that the temperature used for implementing the cryo-extrusion process according to the invention depends on the composition of the product to be extruded. It is well known to those skilled in the art that the initial freezing point of a food product varies according to its composition, in particular according to its water and lipid composition. The richer the food product is in water, the closer the temperature needed to shape it approaches the solidification point of water, i.e. 0° C. On the other hand, if a food product is for example rich in butter, the melting point of which is close to 30° C., a temperature lying between 0° C. and 30° C., which varies depending on the content of water and other constituents, will be sufficient for shaping it.

In the context of the present invention, the term “shaping” is understood to mean the action of giving a food product a defined shape. The cryo-extrusion process according to the invention, by bringing the extruded food product to a temperature slightly below its initial freezing point, makes it possible to give the product a texture which is both soft enough for it to be shaped and solid enough for the shape to be preserved upon exiting the extruder. This shaping is carried out using the nozzle of the extruder, which has a predetermined shape and is placed directly at the exit of the extruder screw. The shapes of nozzles most widely used are stars, squares, circles, triangles, numbers, letters and other personal shapes, but a person skilled in the art is capable of imagining any other shape that can satisfy the demand of the end consumer.

Advantageously, the extruder is refrigerated using a means for circulating a refrigerant around the extruder. The refrigerant may be selected from fluids known to those skilled in the art, such as especially liquid nitrogen, carbon dioxide, brine, ammonia and glycol water.

Preferably, the means for circulating a refrigerant consists of a double-walled jacket which surrounds said at least one extruder screw and in which said refrigerant circulates.

In the context of the invention, the term “double-walled jacket” is understood to mean the combination of an inner first wall surrounding the extruder screw or screws, one face of which is in direct contact with the food product, and an outer second wall concentric with the first so that a space is provided between the first and second walls. Thus, the space provided between the two walls enables a refrigerant to circulate. In this way, the refrigerant is not in direct contact with the food product, but in indirect contact via the inner wall. In general, the jacket has an inlet orifice, via which the coolant is introduced, and an outlet orifice via which the coolant is discharged. Advantageously, the coolant is recycled, either by reinjection into the jacket or by direct injection onto the food product in the feed hopper of the extruder.

In the context of the invention, the double-walled jacket may also be formed from several independent modules joined together by conduits of the hose type, enabling the refrigerant to pass from one module to another. In this particular embodiment, the extruder screw or screws are placed in the cylinder formed by the combination of the jacket modules. Such an embodiment has the advantage of it being possible for the size of the extruder to be rapidly adapted according to the food product or the amount of food product to be extruded.

Advantageously, that surface of said inner jacket wall which is in contact with the food product is maintained at a temperature of about −90° C. or below. This is because the Applicant, during its research, has found that by maintaining the surface of the wall in contact with the food product at a temperature below about −90° C. it is possible for the phenomenon of “zero adhesion” to occur. In other words, at temperatures below −90° C., the food product no longer adheres to the surface of the wall. This phenomenon is not observed in the apparatus of the prior art comprising mechanical refrigeration, the temperatures achieved not being low enough. Such apparatus must therefore face the problem of the food product adhering to the surface of the jacket. Maintaining the surface of the inner jacket wall in contact with the food product at a temperature of about −90° C. or below therefore constitutes a real advantage over the prior art.

Preferably, said refrigerant is liquid nitrogen, which enables that surface of the double-walled jacket in contact with the food product to be easily maintained at a temperature of −90° C. or below.

Preferably, the temperature of said food product is measured at the exit of the extruder screw using a thermometer. This temperature of the food product preferably ranges from about 0.1° C. to about 1° C. below its initial freezing point. The temperature of said food product may also be measured at least at two other points on said at least one extruder screw. Depending on the measured temperature at the exit of the extruder, a person skilled in the art is capable of increasing or decreasing the flow rate of coolant injected into the jacket. If the temperature of the food product at the exit of the screw is too high, i.e. if the food product is too soft to be shaped, the flow rate of injected coolant is increased so that the temperature of the food product is lowered until a texture solid enough for shaping is obtained.

Preferably, the extruder comprises two extruder screws. Advantageously, the extruder comprises two counter-rotating extruder screws.

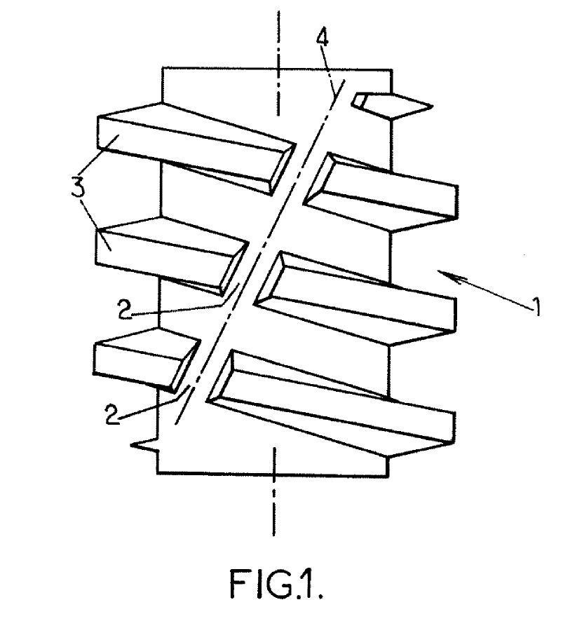

Advantageously, the extruder screw or screws have a particular geometry—alternating sections of the “feed” type, for advancing the food product toward the exit of the extruder, and sections of the “mixer” type, enabling the food product to be mixed so that there is good homogenization of the product inside the extruder. Likewise, mixing the food product allows better distribution of the low temperature in the core of the product. In general, the extruder comprises two counter-rotating extruder screws comprising at least one section of the feed type and at least one section of the mixer type. One screw particularly suitable for carrying out the invention may comprise a mixer first section followed by a feed section, or else a feed first section followed by a mixer section. Another screw suitable for the invention may comprise several alternating, feed/mixer, sections, and it is up to a person skilled in the art to select the screw best suited for the extruded food product. Advantageously, the mixer screw section has a screw thread the opposite of that of the feed section. A nonlimiting and purely illustrative diagram showing a mixer section is given in FIG. 1: the mixer section (1), which is preferably attached to the end of each screw and has a reversed thread, includes grooves (2) via which the food product has to pass. Each flight (3) of this mixer section (1), advantageously of constant pitch, has helically distributed grooves (2), said grooves (2) thus forming between them at least one helix (4), the pitch of which is the reverse of that of the flights (3) of the mixer section (1). The mixer section, mentioned above, is generally attached and fastened by any known means at the end of an extruder screw, but it may possibly form part of the screw itself.

Likewise, the screws used may optionally include a compression zone, i.e. for example a zone in which the screw pitch is progressively reduced or in which the diameter of the screw shaft is increased (for example an increasing screw shaft diameter for a constant screw pitch).

In one embodiment of the invention, the process further includes a step of cutting the extrudate using a cutting means placed directly at the exit of the nozzle. Using this cutting means, the operator, by varying the rate of cutting and/or the extrusion speed, can prepare sized doses of food products. If the cutting rate is increased, the doses will be smaller, while if the cutting rate is reduced, the doses will be larger. In the context of the invention a cutting means may in particular be a cutting wire, a blade, a chopper, shears, a bevel or any other means that can chop the shaped food product cleanly and rapidly. A preferred cutting means is a rotary knife, the blade of which is flush with the exit nozzle of the extruder.

Alternatively, the process as described above may consist in simultaneously shaping two food products by “coextrusion”. Coextrusion proves to be particularly advantageous for the coating of food products or for the manufacture of food products resulting from the combination of several food products, for example different layers so as to have esthetically attractive unitary doses.

Particularly advantageously, the invention also provides for the extrusion set-up parameters to be recorded. Specifically, each food product requires particular set-up data (or “recipe”) for the extruder, and this data may be recorded so that it is sufficient for the operator to tell the computer which product he wishes to extrude in order for the extruder to be automatically set up accordingly. Two types of parameter may in particular be recorded:
the parameters specific to the food product to be extruded, namely for example the initial freezing point of the product, its variation in enthalpy as a function of temperature, which are in particular dependent on the water content of the product, on the fat content, these parameters enabling the shaping temperature of the product to be calculated and, as a consequence, the amount of liquid nitrogen to be delivered to the system; and
the parameters specific to the extruder, namely the number and type of screws, the number and type of jacket modules, the rotation speed of the screw, the motor stopping current.

The operator, having his prerecorded data, will now merely have to parameterize the machine according to the characteristics of its product.

Another subject of the present invention is any food product that can be obtained by the process as described above.

Preferably, the food product is in particular selected from vegetable purees, vegetable timbales, vegetable patties and cakes, chopped spinach, pottage, veloutés, soups, stocks, sauces, prepared dishes, fish preparations, especially fish fingers, pancake preparations, minced meat, sausages, nuggets, frozen herbs, cheese portions, savoury appetizers, cereals, fruits, compotes, sweetened coatings and sauces, water ices, ice creams and iced desserts.

Finally, the subject of the present invention is an installation for shaping at least one food product by cryo-extrusion, comprising:
at least one extruder screw driven by a motor;
a means for detecting an increase in the current drawn by the motor (or in the mechanical force and the speed as seen above), said means being capable of controlling a means for increasing the rotation speed of said at least one extruder screw; and
a nozzle at the exit of said at least one extruder screw.

In the installation according to the invention, said means for detecting an increase in the current drawn by the motor conventionally consists of an ammeter coupled to the motor, making it possible to measure at regular intervals and throughout the cryo-extrusion process, the current drawn by the motor. Still according to the installation of the invention, this current measurement means, when it detects an abnormal rise in current (for example a current above a predetermined setpoint), actuates a means for increasing the rotation speed of the extruder screw or screws. This means for increasing the rotation speed conventionally involves increasing the frequency, for a given time of the order of a few seconds, of the current transmitted by the frequency generator to the screw motor. By increasing the transmitted frequency, the rotation speed of the screw increases.

Advantageously, the installation further includes a means for circulating a refrigerant around said at least one extruder screw.

Preferably, said means for circulating a refrigerant consists of a double-walled jacket which surrounds said at least one extruder screw and in which said refrigerant circulates.

Also preferably, that surface of said double-walled jacket which is in contact with the food product is maintained at a temperature of about −90° C. or below.

Again preferably, said refrigerant is liquid nitrogen.

The installation as described above may additionally include at least one thermometer or another means for measuring a temperature, enabling the temperature of said food product exiting the extruder screw to be measured.

Preferably, the temperature of said food product is also measured at least at two other points on the extruder screw.

Preferably, the installation is characterized in that the extruder comprises two counter-rotating extruder screws. More preferably, the extruder comprises two counter-rotating extruder screws comprising at least one section of the feed type and at least one section of the mixer type. Optionally, each of the extruder screws further includes a compression zone, for compressing the food product.

Advantageously, the installation further includes a cutting means placed directly at the exit of the nozzle, said cutting means enabling the food product formed to be cut into sized portions.

Preferably, said cutting means is selected from a cutting wire, a blade, a chopper, shears, a bevel and a rotary knife.

In one particular embodiment of the invention, the installation further includes a means for recording the extrusion set-up parameters, as described above. This recording means may conventionally consist of an on-board computer for controlling the extruder.

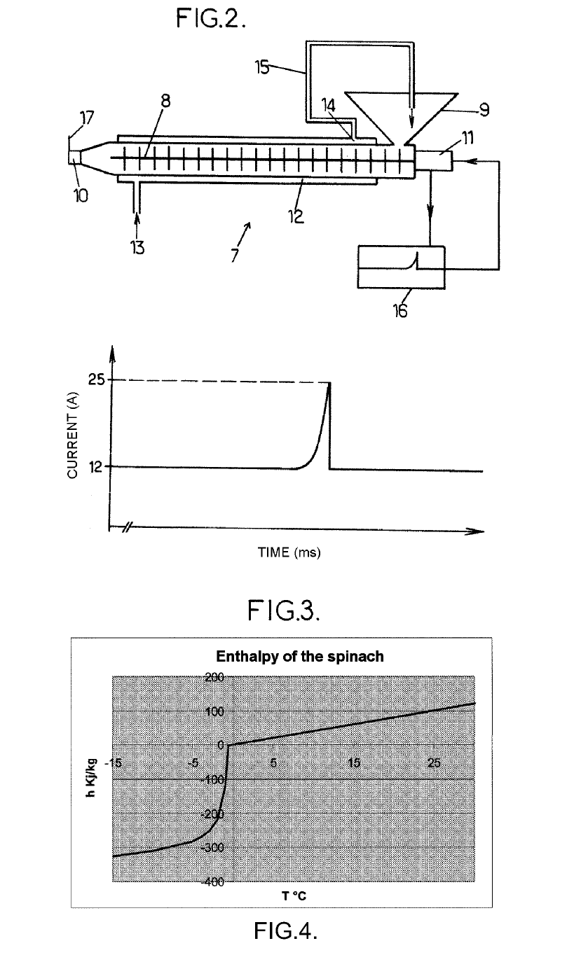

FIG. 2 is a diagram showing one particular installation according to the invention, seen in cross section. The installation (7) consists of an extruder screw (8), a feed hopper (9) and an exit nozzle (10).

The extruder screw (8) is driven by a motor (11). The installation (7) also includes a double-walled jacket (12) surrounding the extruder screw (8). This jacket has an inlet orifice (13) for the coolant, said coolant flowing along the entire length of the jacket around the extruder screw as far as the outlet orifice (14) connected to the conduit (15) for reinjecting the coolant into the feed hopper (9) onto the food product, thus permitting the coolant to be recycled. The motor (11) is connected to a current measuring means (16), which measures the electrical current drawn by the motor (11) over the course of time. In the event of the current drawn by the motor increasing abnormally, a command to increase the rotation speed of the motor is given. The installation further includes a cutting means (17) located at the exit of the nozzle (10) enabling the product, extruded and shaped, to be cut into regular portions.

The present invention will be better understood on reading the implementation example given below as a nonlimiting illustration of the invention.

FIG. 3 is a graph showing the variation in current drawn by the extruder motor as a function of time.

### EXAMPLE 1

### Shaping of Chopped Spinach

Chopped spinach having the following characteristics was extruded:
amount of water in the spinach: 90%
protein and dry matter: 4%
lipids: 1%
carbohydrates: 5%
initial freezing point: −0.8° C. (see the enthalpy graph below).

To do this, an extruder was used having a length of 160 cm and a throughput of 300 kg/hour, the extruder being provided with a feed hopper, a star-shaped exit nozzle and being made up from four modules 40 cm in length, each comprising a double-walled jacket, and two counter-rotating screws, each screw being made up from a feed first section (35 cm in length) and a mixer second section (5 cm in length), as described in FIG. 1. Each jacket of each module is connected to the next one via a hose, and liquid nitrogen was made to circulate within the series-connected jackets so as to cool them to −90° C.

180 liters of liquid nitrogen were needed to cool the extruder and 120 liters of liquid nitrogen per hour were needed to maintain the temperature.

The hopper was then filled with spinach, the extruder was started and the rotation speed of the extruder was set at 10 hertz using the variable frequency supply connected to the motor.

A compact star-shaped extrudate of chopped spinach, the temperature of which was between −1° C. and −2° C., was then recovered at the extruder exit. The star-shaped spinach thus formed was then cut in a regular manner at the extruder exit using a cutting wire, so as to obtain a thickness of 3 cm, and was then frozen.

Throughout the extrusion process, the electrical current drawn by the motor was measured every millisecond. The curve of current as a function of time is given in FIG. 4. The current drawn by the motor was around 12 amps. When at time t an increase in the electrical current drawn by the motor was observed (a peak of about 25 amps), a 6 Hz increase in the extruder screw speed was applied for six seconds. No stopping of the screw was observed.

1-14. (canceled)

15. A process for shaping at least one food product by cryo-extrusion, the process comprising the steps of:
using an extruder to shape at least one food product, the extruder having at least one extruder screw driven by a motor and having a nozzle at an exit of the at least one extruder screw;
measuring a current I drawn by the motor at time tᵢ and time tᵢ₊₁; and
increasing a rotation speed of the at least one extruder screw if a difference in the current ΔI between time tᵢ and time t₊₁ is positive and greater than a predetermined value.

16. The process of claim 15, wherein the extruder is refrigerated using a double-walled jacket which surrounds the at least one extruder screw and in which a refrigerant circulates.

17. The process of claim 16, wherein the refrigerant is liquid nitrogen.

18. The process of claim 16, wherein the double-walled jacket has a surface which is in contact with the at least one food product, the surface being maintained at a temperature of below about −90° C.

19. The process of claim 15, wherein the at least one food product is at a temperature ranging from about 0.1° C. to about 1° C. below its initial freezing point upon exiting the extruder.

20. The process of claim 15, wherein the extruder comprises two extruder screws.

21. The process of claim 20, wherein the extruder comprises two counter-rotating extruder screws.

22. The process of claim 21, wherein the two counter-rotating extruder screws comprise at least one feed section and at least one mixer section.

23. The process of claim 15, further comprising the step of cutting the at least one food product using a cutting means placed directly at an exit of the nozzle, the cutting means enabling the at least one food product to be cut into sized portions, the cutting means being selected from the group consisting of a cutting wire, a blade, a chopper, shears, a bevel, and a rotary knife.

24. The process of claim 15, wherein the process simultaneously shapes two food products.

25. The process of claim 15, further comprising the step of recording in a computer extrusion set-up parameters for at least one food product, so that the operator may indicate to the computer the at least one food product to be extruded in order for the extruder to be automatically set up.

26. The at least one food product obtained by the process of claim 15, wherein the at least one food product is selected from the group consisting of vegetable purees, vegetable timbales, vegetable patties and cakes, chopped spinach, pottage, veloutés, soups, stocks, sauces, prepared dishes, fish preparations, especially fish fingers, pancake preparations, minced meat, sausages, nuggets, frozen herbs, cheese portions, savoury appetizers, cereals, fruits, compotes, sweetened coatings and sauces, water ices, ice creams and iced desserts.

27. An installation for shaping at least one food product by cryo-extrusion, comprising:
at least one extruder screw driven by a motor;
an ammeter adapted to detect an increase in a current drawn by the motor, the ammeter coupled to the motor, the ammeter being capable of controlling a frequency generator adapted to increase a rotation speed of the at least one extruder screw; and
a nozzle at an exit of the at least one extruder screw.

28. The installation of claim 27, further comprising a double-walled jacket which surrounds the at least one extruder screw and in which a refrigerant circulates.

29. The installation of claim 28, wherein the refrigerant is liquid nitrogen.

30. The installation of claim 27, wherein the at least one extruder screw comprises two extruder screws.

31. The installation of claim 30, wherein the at least one extruder screw comprises two counter-rotating extruder screws.

32. The installation of claim 31, wherein the two counter-rotating extruder screws comprise at least one feed section and at least one mixer section.

33. The installation of claim 27, further comprising a cutting means placed directly at an exit of the nozzle, the cutting means enabling the at least one food product to be cut into sized portions, the cutting means selected from the group consisting of a cutting wire, a blade, a chopper, shears, a bevel, and a rotary knife.

34. The installation of claim 27, further comprising a computer for recording extrusion set-up parameters for at least one food product, so that an operator may indicate to the computer the at least one food product to be extruded in order for the installation to be automatically set up.
